(19) United States
(12) Patent Application Publication
(10) Pub. No.: US 2023/0169616 A1
(43) Pub. Date: Jun. 1, 2023

(54) CRYPTOGRAPHIC AUTHENTICATION OF ACTIONS ASSOCIATED WITH REAL PROPERTY

(71) Applicant: Properoots Incorporated, Menlo Park, CA (US)

(72) Inventors: Christopher LICHTI, Menlo Park, CA (US); Michael SUMMERS, Ahwahnee, CA (US); Rinku LICHTI, Menlo Park, CA (US)

(73) Assignee: Properoots Incorporated, Menlo Park, CA (US)

(21) Appl. No.: 18/060,554

(22) Filed: Nov. 30, 2022

Related U.S. Application Data
(60) Provisional application No. 63/284,625, filed on Nov. 30, 2021.

(51) Int. Cl. G06Q 50/16; G06Q 30/0207

(52) U.S. Cl. CPC G06Q 50/16; G06Q 30/0207; G06Q 2220/10

(57) ABSTRACT

A system and method that allow tracking of actions performed on a real estate property and to maintaining trustworthy records of the actions performed.

### FIELD OF THE INVENTION

The present technology is in the field of real estate management and, more specifically, related to tracking actions performed on a real estate property.

### BACKGROUND

Maintaining and performing safety improvements on a real estate property is a challenging endeavor from the standpoint of identifying the maintenance and safety improvements that need to be performed, performing the maintenance and safety improvements, and ensuring that an accurate record of the maintenance and/or safety improvement has been completed. Having the maintenance and safety improvements completed on a real estate property can enhance the occupants' enjoyment of the property, and reduce the risk of an injury. Additionally, the maintenance and safety improvements on a real estate property can reduce the risk to stakeholders such as liability of a real estate owner renting a property, financial loss of a potential buyer purchasing a real estate property, financial loss of a lender with a mortgage on a real estate property that loses value due to lack of maintenance, tax revenue lost by government entities due lack of maintenance of real estate properties, etc.

Creating a list of actions to be performed on a real estate property, such as maintenance and safety improvements, is challenging. This complexity is increased by the ever-changing laws, updated maintenance schedules, new/modified safety recommendations, changing rules of homeowner associations, etc.

Keeping trustworthy records about a real estate property is challenging with regard to certain aspects such as performing maintenance and recommended safety improvements. For example, the buyer of a real estate property typically has to trust that the real estate property maintenance records are accurate. Additionally, real estate property owners and occupants do not have enough time to monitor all proposed law and/or homeowner associations rule changes.

Therefore, what is needed is a system and method to determine actions to be performed on a real estate property, and to maintain trustworthy records of the actions being performed.

### SUMMARY

In accordance with various embodiments and aspects of the invention, systems and methods are disclosed that allows determination of actions to be performed on a real estate property, and to maintain trustworthy records of the actions being or have been performed.

According to one or more aspects and embodiments of the invention, a system is disclosed that includes project management, action tracking, and trustworthy record keeping. According to one or more aspects and embodiments of the invention, record keeping includes using block chain for real estate property records. According to one or more aspects and embodiments of the invention, a benefit of the invention is risk management and community health and safety management by empowering municipalities, insurance companies, and mortgage companies to provide financial incentives for authenticated care and maintenance of a real estate property. According to one or more aspects and embodiments of the invention, a benefit of the invention is to allow real estate property actions to be authenticatable.

### BRIEF DESCRIPTION OF THE DRAWINGS

In order to understand the invention more fully, reference is made to the accompanying drawings. The invention is described in accordance with the aspects and embodiments in the following description with reference to the drawings or figures (FIG.), in which like numbers represent the same or similar elements. Understanding that these drawings are not to be considered limitations in the scope of the invention, the presently described aspects and embodiments and the presently understood best mode of the invention are described with additional detail through use of the accompanying drawings.

FIG. 1 shows a process of managing actions of a real estate property in accordance with the various aspects and embodiments of the invention.

FIG. 2 shows a process of managing actions of a real estate property and providing a reward to a user in accordance with the various aspects and embodiments of the invention.

FIG. 3 shows a process of managing actions of a real estate property that prioritizes the actions in accordance with the various aspects and embodiments of the invention.

FIG. 4 shows a process of managing actions of a real estate property that prioritizes the actions based on the risk of an action not being performed in accordance with the various aspects and embodiments of the invention.

FIG. 5 shows a process of managing actions of a real estate property that prioritizes the actions along with recommending a vendor to perform the action in accordance with the various aspects and embodiments of the invention.

FIG. 6 shows a process of managing actions of managing actions of a real estate property along with creating a property score in accordance with the various aspects and embodiments of the invention.

FIG. 7A illustrates a rotating disk non-transitory computer readable medium, according to an embodiment of the invention.

FIG. 7B illustrates a flash random access memory non-transitory computer readable media, according to an embodiment of the invention.

FIG. 8A illustrates the bottom side of a computer processor-based system-on-chip, according to an embodiment of the invention.

FIG. 8B illustrates the top side of a computer processor-based system-on-chip, according to an embodiment of the invention.

FIG. 9 shows a block diagram for devices with various components, according to an embodiment of the invention.

### DETAILED DESCRIPTION

The following describes various examples of the present technology that illustrate various aspects and embodiments of the invention. Generally, examples can use the described aspects in any combination. All statements herein reciting principles, aspects, and embodiments as well as specific examples thereof, are intended to encompass both structural and functional equivalents thereof. The examples provided are intended as non-limiting examples. Additionally, it is intended that such equivalents include both currently known equivalents and equivalents developed in the future, i.e., any elements developed that perform the same function, regardless of structure.

It is noted that, as used herein, the singular forms “a,” “an” and “the” include plural referents unless the context clearly dictates otherwise. Reference throughout this specification to “one embodiment,” “an embodiment,” “certain embodiment,” “various embodiments,” or similar language means that a particular aspect, feature, structure, or characteristic described in connection with the embodiment is included in at least one embodiment of the invention.

Thus, appearances of the phrases “in one embodiment,” “in at least one embodiment,” “in an embodiment,” “in certain embodiments,” and similar language throughout this specification may, but do not necessarily, all refer to the same embodiment or similar embodiments. Furthermore, aspects and embodiments of the invention described herein are merely exemplary, and should not be construed as limiting of the scope or spirit of the invention as appreciated by those of ordinary skill in the art. The disclosed invention is effectively made or used in any embodiment that includes any novel aspect described herein. All statements herein reciting principles, aspects, and embodiments of the invention are intended to encompass both structural and functional equivalents thereof. It is intended that such equivalents include both currently known equivalents and equivalents developed in the future. Furthermore, to the extent that the terms “including”, “includes”, “having”, “has”, “with”, or variants thereof are used in either the detailed description and the claims, such terms are intended to be inclusive in a similar manner to the term “comprising.”

As actions are taken with respect to real estate property, a system tracks and authenticated the real estate property actions. The overall process executed by the system manages actions and ensures that the actions are authentic and stored in a manner that prevents tampering or alteration of the records.

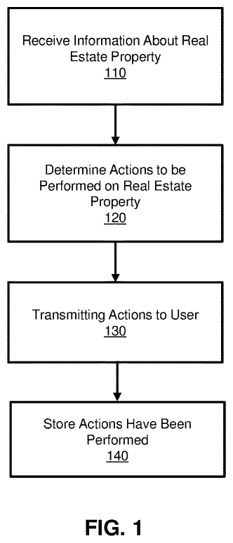

Referring now to FIG. 1, a system executes a process as shown in accordance with the various aspects and embodiments of the invention. The system implements the process of managing actions related to a real estate property in accordance with the various aspects and embodiments of the invention. At step 110, information is received about a real estate property. For example, information can be received from a home inspection, a government record (e.g., county record), a vendor estimate, an invoice, a report, etc. According to one or more aspects and embodiments of the invention, the received information may be any information about a real estate property. According to one or more aspects and embodiments of the invention, a real estate property may be any type of property. For example, real estate property may be a single-family home, a multiple family property, a commercial real estate property, undeveloped land, etc. According to one or more aspects and embodiments of the invention, information about one or more properties is received.

At step 120, one or more actions to be performed on the real estate property is determined using the received information about the real estate property. According to one or more aspects and embodiments of the invention, the real estate information is parsed to determine the actions that need to be performed. In accordance with some aspects and embodiments, the actions that need to be performed are determined based on local laws, local codes, or a schedule for general maintenance requirements. There are many different sources for determining the actions needed to be performed and the impact of those actions on the real estate property. Furthermore, the actions may be determined based on machine learning models that are trained (the requirements as defined based on environmental conditions in light of local laws, regulations, and general best practices) for this specific task and use artificial intelligence. Additional examples of actions include putting in a fire-break on a real estate property, trimming trees that are in too close of proximity of a real estate property, installing a sewer backflow valve, securing a water heater, performing government (e.g., federal, state, local municipality, etc.) recommended actions for protection from an earthquake, etc. According to one or more aspects and embodiments of the invention, the action to be performed may be stored in a ledger (e.g., block chain).

According to one or more aspects and embodiments of the invention, an action may be to inform a user about a real estate property. The informing action may require an acknowledgment. For example, a nearby property may have a proposed zoning change to a commercial property and the user may dismiss this notification since this does not matter to the user. For another example, the user may receive a notification that a city board is considering changing a neighboring house zoning from residential to commercial, and the user may set a reminder to attend the next city board meeting. According to one or more aspects and embodiments of the invention, an action may include title verification for a real estate property.

According to one or more aspects and embodiments of the invention, actions may be grouped into categories, sub-categories, sub-sub-categories, etc. For example, relevant actions may be grouped into a governance category and sub-categories such as zoning, CC&Rs (covenants, conditions & restrictions), government (e.g., city, county, state, federal, etc.) proposed changes and impact of the change, easements, homeowner associations (HOAs), land rights, property line disputes and surveys of record, permits, government council voting records, water rights, etc. For another example, relevant actions may be grouped into a maintenance category and sub-categories such as a maintenance guide (e.g., seasonal, year-round etc.), a home inspection, a real estate repair, structural and landscape engineering (e.g., drainage), pest control, etc. For another example, relevant actions may be grouped into a health and safety category and sub-categories such as health and emergency services (e.g., availability, changes, proposed changes, statistics, etc.), law enforcement (e.g., availability, changes, proposed changes, statistics, etc.), mental health services (e.g., availability, changes, proposed changes, statistics, etc.), emergency services (e.g., availability, changes, proposed changes, statistics, etc.), crime (e.g., statistics, Megan's law, etc.), pandemic (e.g., policies, available services, statistics, etc.).

For another example, relevant actions may be grouped into a recreation and fun category and sub-categories such as local events, parks, playgrounds (e.g., location, accessibility, condition, statistics, etc.), at-home (e.g., opportunities, guides, etc.), etc. For another example, relevant actions may be grouped into an environment category and sub-categories such as natural hazards (e.g., fire, earthquake, tsunami, flood, radon, algae blooms, etc.), climate change (e.g., wildfires, droughts, polar vortices, heat waves, etc.), landfills (e.g., current, homes build on, etc.), blight, cemeteries, unnatural hazards (e.g., factories, chemicals, mines, etc.), light pollution, noise pollution, etc.

For another example, relevant actions may be grouped into an infrastructure category and sub-categories such as transportation (e.g., automobile, train, air, bridge, tolls, etc.), communications (e.g., telecommunications, phone, postal mail, internet connection, etc.), energy (e.g., electricity, gas, etc.), water, sewage, waste management, future plans (e.g., high-speed rail, adding stations, removing stations, upgrading stations, etc.), etc.

For another example, relevant actions may be grouped into a community category and sub-categories such as schools (e.g., ratings, board voting records, plans, etc.), careers (e.g., industries, job opportunities, training, programs, etc.), demographics, activity (e.g., area inspections at different times of the week and day), commerce, religion (e.g., church), etc.

At step 130, the actions are transmitted to a user. According to one or more aspects and embodiments of the invention, a predetermined number of actions may be transmitted to a user. For example, three to five actions may be transmitted to a user. According to one or more aspects and embodiments of the invention, multiple people and/or entities may have the actions sent to them. For example, actions may be transmitted to the user, a tenant of the real estate property, an owner of the real estate property, a manager of the real estate property, a government entity, a bank, a HOA, etc.

According to one or more aspects and embodiments of the invention, additional actions may be transmitted to a user in response to the completion or acknowledgment of previously transmitted actions. According to one or more aspects and embodiments of the invention, actions may be transmitted by any medium that allows the actions to be transmitted to a user. For example, the actions may be transmitted with a website, a web application, a smart phone application, an email, a text, a phone call, an alert (e.g., application push notification), a chat bot, an action feed, etc.

According to one or more aspects and embodiments of the invention, the highest priority actions are transmitted to a user. For example, life threatening actions may be prioritized over maintenance actions. According to one or more aspects and embodiments of the invention, actions may have a combination of priorities. For example, actions may include urgent actions, nice-to-have actions, and fun actions. According to one or more aspects and embodiments of the invention, a user may be given high priority actions initially and a mix of action priorities after the high priority actions are completed. For example, a user may be initially given high priority actions and after a threshold number of actions are completed, a group of actions that include a combination of priority levels may be transmitted.

According to one or more aspects and embodiments of the invention, action priority is based on the emotional and financial impact. According to one or more aspects and embodiments of the invention, transmitting actions include transmitting a deadline to the action to be completed. According to one or more aspects and embodiments of the invention, actions are transmitted based on when an action needs to be performed. For example, a winterizing action may be sent to the user a week before the temperature is expected to drop below freezing.

At step 140, a determination is made that an action was performed on a real estate property and completion of the action is stored in a ledger. According to one or more aspects and embodiments of the invention, the ledger provides authenticated secure information to a consumer. According to one or more aspects and embodiments of the invention, the ledger is a block chain. According to one or more aspects and embodiments of the invention, the ledger is immutable. According to one or more aspects and embodiments of the invention, the ledger is a database. According to one or more aspects and embodiments of the invention, the ledger is a combination of block chain and a database. According to one or more aspects and embodiments of the invention, the ledger is stored by a trusted entity. According to one or more aspects and embodiments of the invention, the trusted entity is a government entity. According to one or more aspects and embodiments of the invention, the records associated with the real estate property that are maintained by the system and authentic can be transferred to the next owner of the real estate property, for example upon a change in title/ownership.

According to one or more aspects and embodiments of the invention, the user may report updates related to a percent of any action that is performed for the real estate property or related to the real estate property. For example, the user may report that an action is fifty percent complete. According to one or more aspects and embodiments of the invention, actions may be transmitted with milestones and the user may report when a milestone is complete.

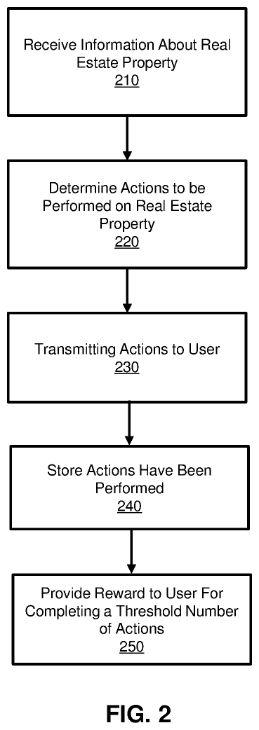

Referring now to FIG. 2, shown is a process of managing actions of a real estate property and providing a reward to a user in accordance with the various aspects and embodiments of the invention. At step 210, information is received about a real estate property. According to one or more aspects and embodiments of the invention, step 210 is the same or similar to step 110. At step 220, one or more actions to be performed on the real estate property is determined using the received information about the real estate property. According to one or more aspects and embodiments of the invention, step 220 is the same or similar to step 120. At step 230, the actions are transmitted to a user. According to one or more aspects and embodiments of the invention, step 240 is the same or similar to step 130. At step 240, a determination is made that an action was performed on a real estate property and completion of the action is stored in a ledger. According to one or more aspects and embodiments of the invention, step 240 is the same as or similar to step 140.

At step 250, a reward is provided to the user for completing a threshold number of actions. For example, a financial reward may be an insurance discount from an insurance provider, a tax incentive from a government agency, a mortgage discount from a mortgage lender, etc. According to one or more aspects and embodiments of the invention, actions and/or completed actions for a specific real estate property may be compared to another real estate property. The respective real estate property owners and/or tenants may engage in a competition to complete the actions. For example, the user may receive a badge in an application for completing a predetermined number of actions. According to one or more aspects and embodiments of the invention, a benefit of a competition is to motivate a user to perform an action while avoiding other distractions in the life of the user. The competition may be between multiple neighbors, multiple neighborhoods, multiple cities, and any other division of real estate property. According to one or more aspects and embodiments of the invention, users may track the progression of outstanding and completed actions of other users. Users may comment and congratulate other uses for making progression in completing actions. According to one or more aspects and embodiments of the invention, the health benefit of a user of performing the action is determined. The user may receive a reward based on the health benefit a user will achieve for completing the action.

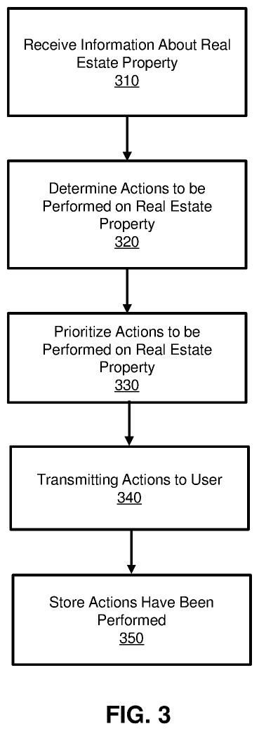

Referring now to FIG. 3, shown is a process of managing actions of a real estate property that prioritizes the actions in accordance with the various aspects and embodiments of the invention. At step 310, information is received about a real estate property. According to one or more aspects and embodiments of the invention, step 310 is the same or similar to step 110. At step 320, one or more actions to be performed on the real estate property is determined using the received information about the real estate property. According to one or more aspects and embodiments of the invention, step 320 is the same or similar to step 120.

At step 330, the actions to be performed on the real estate property are prioritized. For example, life threatening actions may be prioritized over maintenance actions. According to one or more aspects and embodiments of the invention, actions may have a combination of priorities. For example, actions may include urgent actions, nice-to-have actions, and fun actions. According to one or more aspects and embodiments of the invention, a user may be given high priority actions initially and a mix of action priorities after the high priority actions are completed. For example, a user may be initially given high priority actions and after a threshold number of actions are completed, a group of actions that include a combination of priority levels may be transmitted.

According to one or more aspects and embodiments of the invention, action priority is based on the emotional and financial impact. According to one or more aspects and embodiments of the invention, transmitting actions include transmitting a deadline for the action to be completed. According to one or more aspects and embodiments of the invention, actions are transmitted based on when an action needs to be performed. For example, a winterizing action may be sent to the user a week before the temperature is expected to drop below freezing. According to one or more aspects and embodiments of the invention, a benefit of prioritization is to reduce the cognitive load on the user by showing the highest priority actions first and limiting the number of actions the user has to consume at a time. According to one or more aspects and embodiments of the invention, the actions are prioritized based on categories the user selects. According to one or more aspects and embodiments of the invention, step 330 is the same or similar to the prioritization of step 110.

At step 340, the actions are transmitted to a user. According to one or more aspects and embodiments of the invention, step 340 is the same or similar to step 130. At step 350, a determination is made that an action was performed on a real estate property and completion of the action is stored in a ledger. According to one or more aspects and embodiments of the invention, step 350 is the same or similar to step 140.

According to one or more aspects and embodiments of the invention, prioritization of the action may be performed on the device of the user.

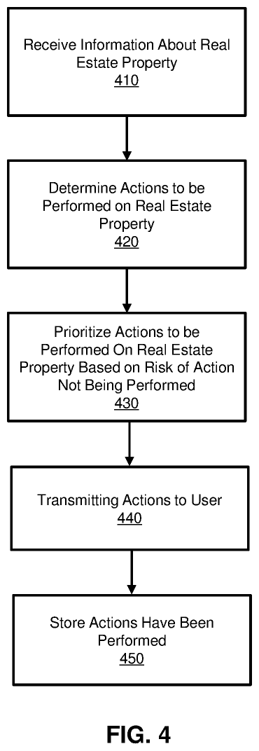

Referring now to FIG. 4, shown is a process of managing actions of a real estate property, which prioritizes the actions based on the risk of an action not being or that is not performed, in accordance with the various aspects and embodiments of the invention. At step 410, information is received about a real estate property. According to one or more aspects and embodiments of the invention, step 410 is the same or similar to step 110. At step 420, one or more actions to be performed on the real estate property is determined using the received information about the real estate property. According to one or more aspects and embodiments of the invention, step 420 is the same or similar to step 120.

At step 430, the actions to be performed on the real estate property are prioritized based on the risk of an action not being performed. For example, when a real estate property is in a geographic region that has a high risk of an earthquake, an earthquake mitigation action would have a higher priority compared to a wildfire mitigation action. According to one or more aspects and embodiments of the invention, risk includes the risk of a possible injury to an occupant of the real estate property. According to one or more aspects and embodiments of the invention, risk includes the risk of possible damage to a real estate property. According to one or more aspects and embodiments of the invention, risk includes a combination of the risk of a possible injury to an occupant of the real estate property and risk of possible damage to the real estate property. According to one or more aspects and embodiments of the invention, priority is based on the deadlines of each action to be completed. According to one or more aspects and embodiments of the invention, step 430 is the same or similar to step 330.

At step 440, the actions are transmitted to a user. According to one or more aspects and embodiments of the invention, step 440 is the same or similar to step 130. At step 450, a determination is made that an action was performed on a real estate property and completion of the action is stored in a ledger. According to one or more aspects and embodiments of the invention, step 450 is the same or similar to step 140.

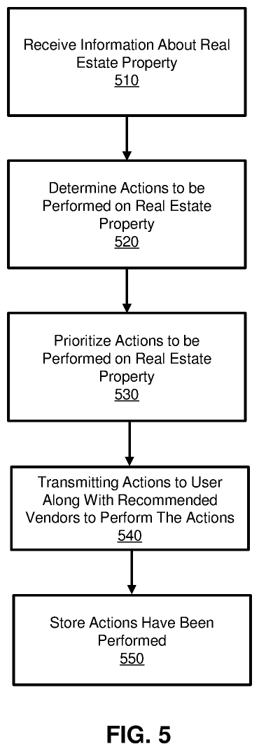

Referring now to FIG. 5, shown is a process of managing actions of a real estate property that prioritizes the actions along with recommending a vendor to perform the action in accordance with the various aspects and embodiments of the invention. At step 510, information is received about a real estate property. According to one or more aspects and embodiments of the invention, step 510 is the same or similar to step 110. At step 520, one or more actions to be performed on the real estate property is determined using the received information about the real estate property. According to one or more aspects and embodiments of the invention, step 520 is the same or similar to step 120. At step 530, the actions to be performed on the real estate property are prioritized. According to one or more aspects and embodiments of the invention, step 530 is the same or similar to steps 330 and/or 430.

At step 540, actions are transmitted to the user along with a recommended vendor for one or more of the actions. For example, when the actions include an action to trim trees on the real estate property, the action may include a recommended vendor to perform the tree trimming. According to one or more aspects and embodiments of the invention, the user is given the ability to schedule the vendor to perform each action. According to one or more aspects and embodiments of the invention, the user may indicate that the user wishes the system (process) to manage performing the action. For example, after the user indicates the desire to have actions performed, the system (process) schedules with the vendor to perform the service, tracks the progress of the service, compensates the vendor, receives compensation from the user, and records that the action has been completed. In accordance with some aspects and embodiments of the invention, the system determines that the vendor needs to quote the job before performing the action. The system can provide information to the vendor, for example information from a home inspection. Thus, the system can ensure that the vendor has all the information needed beforehand. Additionally, in the example of a remodel or construction work, the system can set up a time or schedule a consultation for the vendor to meet with or talk to the owner and see the job site or the property.

According to one or more aspects and embodiments of the invention, transmitting the actions of step 540 may be the same or similar to step 130. According to one or more aspects and embodiments of the invention, since a vendor is compensated by the system, the vendor is less biased in vendors assessment. Contrast this with a vendor compensated by a real estate transaction, in which the vendor is incentivized to complete the real estate transaction.

At step 550, a determination is made that an action was performed on a real estate property and completion of the action is stored in a ledger. According to one or more aspects and embodiments of the invention, step 550 is the same or similar to step 140.

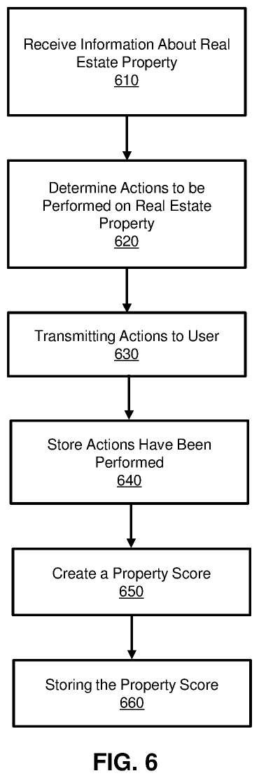

Referring now to FIG. 6, shown is a process of managing actions of a real estate property along with creating a property score in accordance with the various aspects and embodiments of the invention. At step 610, information is received about a real estate property. According to one or more aspects and embodiments of the invention, step 610 is the same or similar to step 110. At step 620, one or more actions to be performed on the real estate property is determined using the received information about the real estate property. According to one or more aspects and embodiments of the invention, step 620 is the same or similar to step 120. At step 630, the actions are transmitted to a user. According to one or more aspects and embodiments of the invention, step 630 is the same or similar to step 130. At step 640, a determination is made that an action was performed on a real estate property and completion of the action is stored in a ledger. According to one or more aspects and embodiments of the invention, step 640 is the same or similar to step 140. At step 650, a property score is created. According to one or more aspects and embodiments of the invention, the property score is determined based on a various actions taken and relative importance of those action for the maintenance and upkeep of the real estate property. The scope of the invention is not limited by the means for determining the property score, the weight given to each task performed, or the various factors or tasks that make up the score.

At step 660, the property score is stored. According to one or more aspects and embodiments of the invention, the property score is added to the ledger. According to one or more aspects and embodiments of the invention, the property score of multiple real estate properties is used to compare the properties. For example, a home buyer could see the property score in the home buying process for each property the home buyer is considering to purchase.

According to one or more aspects and embodiments of the invention, method for tracking actions for a real estate property is disclosed, the method includes receiving information from one or more sources regarding the real estate property; determining one or more actions that need to be performed on the real estate property based on the received information; prioritizing the one or more actions to be performed on the real estate property; transmitting the one or more actions to a user; determining if one or more actions on the real estate property has been performed; and storing one or more actions that has been performed on the real estate property; wherein the stored one or more action provide authenticated secure information to a consumer.

According to one or more aspects and embodiments of the invention, the method for tacking actions for a real estate property includes storing at least partially performed on a blockchain to ensure authenticity.

According to one or more aspects and embodiments of the invention, the method for tacking actions for a real estate property includes limiting the one or more prioritized actions to a predetermined number of actions or a predetermined sequence of actions.

According to one or more aspects and embodiments of the invention, the method for tacking actions for a real estate property includes prioritizing based on one or more categories that the user selects.

According to one or more aspects and embodiments of the invention, the method for tacking actions for a real estate property includes the one or more categories include at least one of governance, maintenance, health, safety, recreation, entertainment, environment, infrastructure, and community.

According to one or more aspects and embodiments of the invention, the method for tacking actions for a real estate property includes prioritizing is based on a risk of the action not being performed.

According to one or more aspects and embodiments of the invention, the method for tacking actions for a real estate property includes the risk includes possibility of an injury to an occupant of the real estate property.

According to one or more aspects and embodiments of the invention, the method for tacking actions for a real estate property includes the risk includes another risk of damage to the real estate property.

According to one or more aspects and embodiments of the invention, the method for tacking actions for a real estate property includes prioritizing is based on the preference of the user.

According to one or more aspects and embodiments of the invention, the method for tacking actions for a real estate property includes prioritizing is based on a deadline for a maintenance action to be performed.

According to one or more aspects and embodiments of the invention, the method for tacking actions for a real estate property includes storing includes storing by a trusted entity.

According to one or more aspects and embodiments of the invention, the method for tacking actions for a real estate property includes the trusted entity is a government entity.

According to one or more aspects and embodiments of the invention, the method for tacking actions for a real estate property includes one or more of the actions include acknowledgment of a proposed change affecting the real estate property.

According to one or more aspects and embodiments of the invention, the method for tacking actions for a real estate property includes the proposed change is from a government entity.

According to one or more aspects and embodiments of the invention, the method for tacking actions for a real estate property includes the proposed change is from a home owners association.

According to one or more aspects and embodiments of the invention, the method for tacking actions for a real estate property includes transmitting the prioritized actions include one or more recommendations of one or more vendors to perform the respective one or more prioritized actions.

According to one or more aspects and embodiments of the invention, the method for tacking actions for a real estate property includes creating a property score for the real estate property; and storing the score for future access and information sharing that is authenticated.

According to one or more aspects and embodiments of the invention, the method for tacking actions for a real estate property includes the one or more actions include performing and completing title verification of the real estate property.

According to one or more aspects and embodiments of the invention, the method for tacking actions for a real estate property includes transmitting one or more completed actions to one or more other users.

According to one or more aspects and embodiments of the invention, the method for tacking actions for a real estate property includes comparing completed or pending actions of the real estate property with completed or pending actions, respectively, for at least one other real estate property in proximity to the real estate property.

According to one or more aspects and embodiments of the invention, the method for tacking actions for a real estate property includes providing a financial incentive for completion of a threshold number of the actions.

According to one or more aspects and embodiments of the invention, the method for tacking actions for a real estate property includes the financial incentive includes at least one of financial incentive from government entity, financial incentive from an insurance provider, and financial incentive from a mortgage lender.

According to one or more aspects and embodiments of the invention, a system includes at least one processor; memory in communication with the processor, wherein the memory stores code that is executed by the processor and causes the system to: receive information from one or more sources regarding a property; select one or more actions to be performed with respect to the based on the received information; transmit the one or more selected actions to a user; determine if the one or more actions on the real estate property has been performed; store the one or more performed actions and property specific information; and validate the property specific information using an authentication scheme thereby allowing future transmission of the property specific information to a receiver such that the receiver of the property specific information knows the authenticity and accuracy of the property specific information, as received.

According to one or more aspects and embodiments of the invention, a method for tracking data for a real estate property, the method includes receiving information from one or more sources regarding the real estate property; verifying the information; and storing the information in a manner that enables trusted relationships to be built regarding the property. According to one or more aspects and embodiments of the invention, data includes current data, historical data, and changes to the data. According to one or more aspects and embodiments of the invention, tracking is done in real time. According to one or more aspects and embodiments of the invention, tacking is done in near real time. According to one or more aspects and embodiments of the invention, verifying the information includes verifying actions, reports, decisions, etc. According to one or more aspects and embodiments of the invention, verifying includes verifying accuracy, completeness, and authenticity of data.

According to one or more aspects and embodiments of the invention, data features include one or more of the following: sequential (e.g., all data transactions are accepted sequentially), agreed (e.g., data transactions are accepted based on agreement of all parties/nodes/systems involved), ledgered (e.g., agreed upon data are appended and cannot be revoked, changed, or deleted), and tamper resistant (e.g., data cannot be manipulated or censored).

According to one or more aspects and embodiments of the invention, systemic features one or more of the following: symmetric (e.g., all nodes share all responsibilities symmetrically), admin-free (e.g., fully peer-to-peer with no centralized administration), timely (e.g., data transactions are processed and stored efficiently to ensure timely processing and availability of new data), secure (e.g., practically impossible to gain unauthorized access to data), and protects the privacy of property owners by giving them control over who has access to their data.

According to one or more aspects and embodiments of the invention, benefits include one or more of the following: lower cost, strong authenticity (e.g., data about a property is classified by authenticity in a range from sourced to validated by trusted authorities), aligned Incentives, resilient to data loss, and globally consistent.

According to one or more aspects and embodiments of the invention, a repair validation example includes a smart contract (e.g., ProperContract) that enforces multi-party effort to complete repairs or improvements to properties. The features include one or more of the following: fully automated contract enforced by code (e.g. in a blockchain); independent, trusted relationships between a trusted provider (e.g., Properoots) and services; independent, trusted relationships between trusted provider (e.g., Properoots) and inspectors; before and after photos confirming completed repairs or improvements; human and/or AI validation the photos prove the repairs or improvements were completed; and payments and/or discounts transferred or applied directly by trusted provider (e.g., ProperContract), (e.g., actual exchange that is built into the contract—triggering of work flow). According to one or more aspects and embodiments of the invention, the trusted provider identifies and maintains a database of vendor that are trusted and reliable and uses this database for handling and performing tasks for the owner of the real estate property.

According to one or more aspects and embodiments of the invention, application of the invention includes: determining one or more actions that need to be performed on the real estate property based on the received information; prioritizing the one or more actions to be performed on the real estate property; transmitting the one or more actions to a user; determining if one or more actions on the real estate property has been performed; and storing one or more actions that has been performed on the real estate property, wherein the stored one or more action provide authenticated secure information to a consumer.

According to one or more aspects and embodiments of the invention, a revenue stream includes software (e.g., software as a service (SaaS)) for homeowners to subscribe to. For example, protect lives by determining actions necessary to protect the lives and health of those who own or reside on the property. For example, protect liberty, determining actions necessary to maximize the freedoms and opportunities for those who own or reside on the property. For example, protect pursuit of happiness by determining actions available to maximize the happiness of those who own or reside on the property. According to one or more aspects and embodiments of the invention, a revenue stream includes software (e.g., SaaS) to municipalities (e.g., building, title, planning and development). For example, mutually beneficial revenue streams for the building, planning, tax, development, and other property-related departments of municipalities. According to one or more aspects and embodiments of the invention, a revenue stream includes transaction fees (e.g., flat or percent of transaction) for home repairs and preventative maintenance. According to one or more aspects and embodiments of the invention, a revenue stream includes data subscription. For example, aggregated/anonymized data for insurance companies. According to one or more aspects and embodiments of the invention, a revenue stream includes lead generation fees (e.g., for vendors to find homeowner customers). According to one or more aspects and embodiments of the invention, a revenue stream includes ad targeting (e.g., targeting based on data about properties). According to one or more aspects and embodiments of the invention, a revenue stream includes title search fees (e.g., instant report as part of real estate transactions). According to one or more aspects and embodiments of the invention, a revenue stream includes home inspection fees. For example, enriched with rapidly evolving methods for change (e.g., climate change, societal changes). According to one or more aspects and embodiments of the invention, a revenue stream includes home inspection certification fees. According to one or more aspects and embodiments of the invention, home inspection classes.

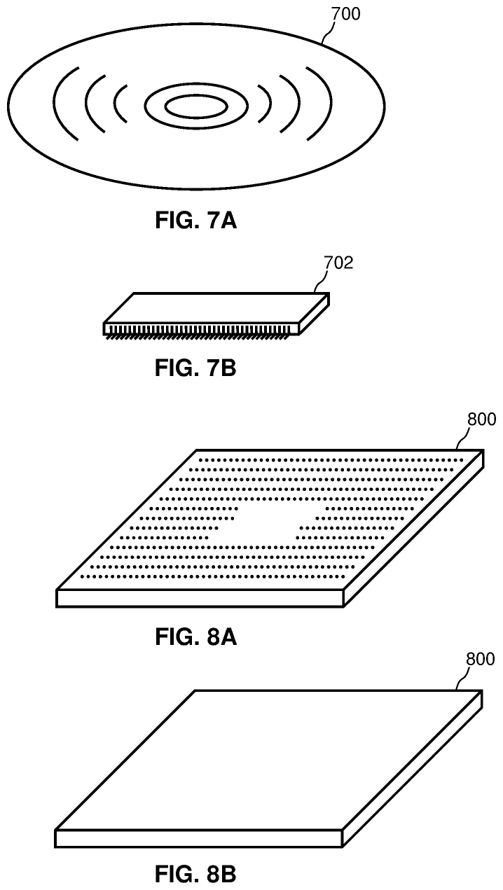

Referring now to FIG. 7A, shown is a non-transitory computer readable rotating disk medium 700 that stores computer code that, if executed by a computer processor, would cause the computer processor to perform methods or partial method steps described herein.

Referring now to FIG. 7B, shown is a non-transitory computer readable random-access memory (RAM) chip medium 702 that stores computer code that, if executed by a computer processor, would cause the computer processor to perform methods or partial method steps described herein.

Referring now to FIG. 8A, shown is the bottom (solder ball) side of a processor that includes a system-on-chip (SoC) 800, which includes multiple computer processor cores having a component of some embodiments of the invention and that, by executing computer code, perform methods or partial method steps described herein.

Referring now to FIG. 8B, shown is the top side of the SoC 800.

The example of the one or more non-transitory computer readable media arranged to store such instructions for methods described herein. Whatever machine, which holds non-transitory computer readable media including any of the necessary code, may implement an example or an aspect of the invention. Some examples may be implemented as: physical devices such as semiconductor chips; hardware description language representations of the logical or functional behavior of such devices; and one or more non-transitory computer readable media arranged to store such hardware description language representations. Descriptions herein reciting principles, aspects, and embodiments encompass both structural and functional equivalents thereof. Elements described herein as coupled have an effectual relationship realizable by a direct connection or indirectly with one or more other intervening elements.

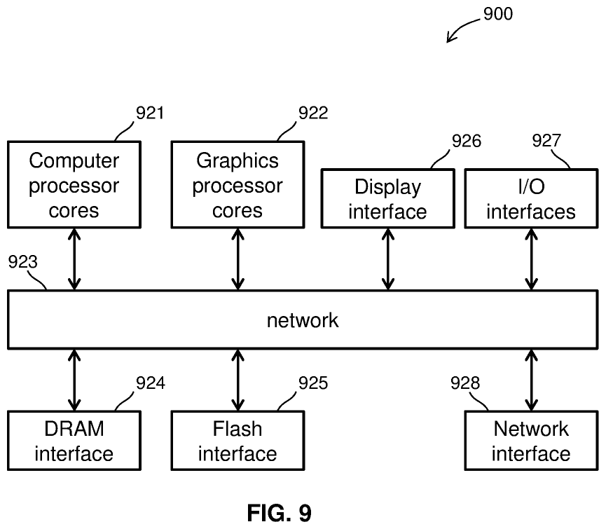

Referring now to FIG. 9, a block diagram of the cores within a system 900, which may be a system-on-chip (SoC), is shown. The system 900 includes a multi-core computer processor (CPU) 921 and a multi-core graphics accelerator processor (GPU) 922. The CPU 921 and GPU 922 are connected through a network 923, which may be a network-on-chip or an interconnect, to a DRAM interface unit 924 and a Flash RAM interface unit 925. A display interface unit 926 controls a display, enabling the system 900 to output MPEG video and JPEG still image message content. An I/O interface unit 927 provides for speaker and microphone access for the human-machine interface of a device controlled by the system 900. A network interface unit 928 provides access for the system 900 to communicate with remote locations (such as servers) over the internet or a wireless network or a local area network.

Certain methods according to the various aspects of the invention may be performed by instructions that are stored upon a non-transitory computer readable medium. The non-transitory computer readable medium stores code including instructions that, if executed by one or more processors, would cause a system or computer to perform steps of the method described herein. The non-transitory computer readable medium includes: a rotating magnetic disk, a rotating optical disk, a flash random access memory (RAM) chip, and other mechanically moving or solid-state storage media. Any type of computer-readable medium is appropriate for storing code having instructions according to various examples and aspects of the invention.

Certain examples have been described herein and it will be noted that different combinations of different components from different examples may be possible. Salient features are presented to better explain examples; however, it is clear that certain features may be added, modified, and/or omitted without modifying the functional aspects of these examples as described.

Practitioners skilled in the art will recognize many modifications and variations. The modifications and variations include any relevant combination of the disclosed features. Descriptions herein reciting principles, aspects, and embodiments encompass both structural and functional equivalents thereof. Elements described herein as “coupled” or “communicatively coupled” have an effectual relationship realizable by a direct connection or indirect connection, which uses one or more other intervening elements. Embodiments described herein as “communicating” or “in communication with” another device, module, or elements include any form of communication or link and include an effectual relationship. For example, a communication link may be established using a wired connection, wireless protocols, near-filed protocols, or RFID.

Certain methods according to the various aspects of the invention may be performed by instructions that are stored upon a non-transitory computer readable medium. The non-transitory computer readable medium stores code including instructions that, if executed by one or more processors, would cause a system or computer to perform steps of the method described herein. The non-transitory computer readable medium includes: a rotating magnetic disk, a rotating optical disk, a flash random access memory (RAM) chip, and other mechanically moving or solid-state storage media. Any type of computer-readable medium is appropriate for storing code having instructions according to various examples and aspects of the invention.

Certain examples have been described herein and it will be noted that different combinations of different components from different examples may be possible. Salient features are presented to better explain examples; however, it is clear that certain features may be added, modified, and/or omitted without modifying the functional aspects of these examples as described.

The scope of the invention, therefore, is not intended to be limited to the exemplary embodiments and aspects that are shown and described herein. Rather, the scope and spirit of the invention is embodied by the appended claims.

What is claimed is:

1. A method for tracking actions for a real estate property, the method comprising:
receiving information from one or more sources regarding the real estate property;
determining one or more actions that need to be performed on the real estate property based on the received information;
prioritizing the one or more actions to be performed on the real estate property;
transmitting the one or more actions to a user;
determining if one or more actions on the real estate property has been performed; and
storing one or more actions that has been performed on the real estate property, wherein the stored one or more action provide authenticated secure information to a consumer.

2. The method of claim 1, wherein storing is at least partially performed on a blockchain to ensure authenticity.

3. The method of claim 1, wherein transmitting includes limiting the one or more prioritized actions to a predetermined number of actions.

4. The method of claim 1, wherein prioritizing is based on one or more categories that the user selects and wherein the one or more categories include at least one of governance, maintenance, health, safety, recreation, entertainment, environment, infrastructure, and community.

5. The method of claim 1, wherein prioritizing is based on a risk of the action not being performed, the risk includes possibility of an injury to an occupant of the real estate property, and the risk includes another risk of damage to the real estate property.

6. The method of claim 1, wherein prioritizing is based on the preference of the user.

7. The method of claim 1, wherein prioritizing is based on a deadline for a maintenance action to be performed.

8. The method of claim 1, wherein storing includes storing by a trusted entity and the trusted entity is a government entity.

9. The method of claim 1, wherein one or more of the actions include acknowledgment of a proposed change affecting the real estate property and the proposed change is from at least one of from a government entity and a home owners association.

10. The method of claim 1, wherein transmitting the prioritized actions include one or more recommendations of one or more vendors to perform the respective one or more prioritized actions.

11. The method of claim 1, further comprising:
creating a property score for the real estate property; and
storing the score for future access and information sharing that is authenticated.

12. The method of claim 1, wherein the one or more actions include performing and completing title verification of the real estate property and further comprising transmitting one or more completed actions to one or more other users.

13. The method of claim 1, further comprising comparing completed or pending actions of the real estate property with completed or pending actions, respectively, for at least one other real estate property in proximity to the real estate property.

14. The method of claim 1 further comprising providing a financial incentive for completion of a threshold number of the actions, wherein the financial incentive includes at least one of financial incentive from government entity, financial incentive from an insurance provider, and financial incentive from a mortgage lender.

15. A system comprising:
at least one processor;
memory in communication with the processor, wherein the memory stores code that is executed by the processor and causes the system to:
receive information from one or more sources regarding a property;
select one or more actions to be performed with respect to the based on the received information;
transmit the one or more selected actions to a user;
determine if the one or more actions on the real estate property has been performed;
store the one or more performed actions and property specific information; and
validate the property specific information using an authentication scheme thereby allowing future transmission of the property specific information to a receiver such that the receiver of the property specific information knows the authenticity and accuracy of the property specific information, as received.

16. A method for tracking actions for a real estate property, the method comprising storing one or more actions that has been performed on the real estate property, wherein the stored one or more actions are authenticated and secure.
